(19) United States
(12) Patent Application Publication
(10) Pub. No.: US 2017/0160431 A1
(43) Pub. Date: Jun. 8, 2017

(54) QUANTUM DOT SHEET, MANUFACTURING METHOD THEREOF AND DISPLAY APPARATUS INCLUDING THE SAME

(71) Applicant: Samsung Display Co., Ltd., Yongin-Si (KR)

(72) Inventors: Junwoo YOU, Seongnam-si (KR); Taeho LEE, Hwaseong-si (KR)

(21) Appl. No.: 15/196,213

(22) Filed: Jun. 29, 2016

(30) Foreign Application Priority Data
Dec. 3, 2015 (KR) 10-2015-0171674

(51) Int. Cl. G02B 1/04; F21V 8/00

(52) U.S. Cl. CPC G02B 1/04; G02B 6/005; G02B 6/0026

(57) ABSTRACT

A quantum dot sheet of a backlight assembly for a display apparatus includes: light conversion fibers which convert a wavelength of light provided to the quantum dot sheet; and a first polymer layer in which the light conversion fibers are disposed. Each of the light conversion fibers is defined by: first quantum dots which convert the wavelength of the light provided to the quantum dot sheet, and a base fiber comprising an inorganic material and in which the first quantum dots are disposed.

This application claims priority to Korean Patent Application No. 10-2015-0171674, filed on Dec. 03, 2015, and all the benefits accruing therefrom under 35 U.S.C. §119, the contents of which in their entirety are herein incorporated by reference.

### BACKGROUND

The invention is directed to a quantum dot sheet, a manufacturing method thereof and a display apparatus including the same, and more particularly, to a quantum dot sheet including a quantum dot, a manufacturing method thereof and a display apparatus including the same.

In general, a display apparatus includes a display panel for displaying an image with light and a backlight unit providing the display panel with the light. The display panel adjusts the transmittance of the light received from the backlight unit and thereby displays an image.

The backlight unit may be classified into an edge type in which light is provided to the display panel from a side surface of the display panel, and a direct type in which light is provided to the display panel from under the display panel.

The edge-type backlight unit includes a light source for generating light, a light guide plate for guiding the direction of light to the display panel, and an optical sheet for controlling the path of the light emitted from the light guide plate to the display panel. The light source is disposed on one side of the light guide plate, and the light guide plate guides the light generated from the light source toward the optical sheet. The optical sheet spreads and collects the incident light from the light guide plate and provides the display panel with the light.

### SUMMARY

One or more exemplary embodiment of the invention provides a quantum dot sheet for which deterioration thereof is reduced or effectively prevented.

One or more exemplary embodiment of the invention also provides a method for manufacturing quantum dot sheet for which deterioration thereof is reduced or effectively prevented.

One or more exemplary embodiment of the invention also provides a method for manufacturing quantum dot sheet having a decreased overall thickness and a decreased bezel thereof.

According to an exemplary embodiment of the invention, a quantum dot sheet is provided. The quantum dot sheet includes: light conversion fibers which convert a wavelength of light provided to the quantum dot sheet; and a first polymer layer in which the light conversion fibers are disposed. Each of the light conversion fibers is defined by: first quantum dots which convert the wavelength of the light provided to the quantum dot sheet, and a base fiber including an inorganic material and in which the first quantum dots are disposed.

The light conversion fibers may form a mesh shape.

The inorganic material of the base fibers may have a light transmitting property.

The inorganic material may include at least one of SiO₂, Al₂O₃, ZrO₂ and ZnO.

The quantum dot sheet may further include a first barrier film; a second barrier film facing the first barrier film; second quantum dots which convert the wavelength of the light provided to the quantum dot sheet, and a second polymer layer in which the second quantum dots are disposed, the second polymer layer with the second quantum dots disposed therein being between the first barrier film and the second barrier film. A first structure of the quantum dot sheet may be defined by the first polymer layer having the light conversion fibers disposed therein, a second structure of the quantum dot sheet may be defined by the second polymer layer being between the first barrier film and the second barrier film and having the second quantum dots disposed therein, and in a top plan view, the first structure may surround the second structure.

The first polymer layer and the second polymer layer may include a thermosetting polymer.

An exemplary embodiment of the invention provides a display apparatus. The display apparatus includes: a display panel which receives light to display an image; and a backlight assembly which provides the light to the display panel. The backlight assembly includes: a light source which generates and emits the light; and a quantum dot sheet which is disposed adjacent to the light source and the display panel and converts a wavelength of the light provided from the light source. The quantum dot sheet includes: light conversion fibers which convert the wavelength of the light provided from the light source, and a first polymer layer in which the light conversion fibers are disposed. Each of the light conversion fibers is defined by: first quantum dots which convert the wavelength of the light provided from the light source, and a base fiber including an inorganic material and in which the first quantum dots are disposed.

The backlight assembly may further include a light guide plate, and the quantum dot sheet may be disposed between the light guide plate and the display panel.

The backlight assembly may further include a light guide plate, and the quantum dot sheet may be disposed between the light guide plate and the light source.

The light conversion fibers of the quantum dot sheet may form a mesh shape.

The inorganic material of the base fiber of the quantum dot sheet may have a light transmitting property.

The quantum dot sheet may further include a first barrier film; a second barrier film facing the first barrier film; second quantum dots which convert the wavelength of the light provided from the light source, and a second polymer layer in which the second quantum dots are disposed, the second polymer layer with the second quantum dots disposed therein being between the first barrier film and the second barrier film. A first structure of the quantum dot sheet may be defined by the first polymer layer having the light conversion fibers disposed therein, a second structure of the quantum dot sheet may be defined by the second polymer layer being between the first barrier film and the second barrier film and having the second quantum dots disposed therein, and in a top plan view, the first structure may surround the second structure.

An exemplary embodiment of the invention provides a method for manufacturing a quantum dot sheet, including: preparing a combined solution by providing a quantum dot material to an original solution including a transparent inorganic material; forming light conversion fibers by spinning the combined solution; and forming a first polymer layer so as to cover the spun light conversion fiber, to form the quantum dot sheet.

The forming of the light conversion fibers may include: forming the light conversion fibers in a mesh shape; and drying the light conversion fibers in the mesh shape.

The light conversion fibers may be formed through an electrospinning method.

A preliminary sheet may be defined by the light conversion fibers formed in the mesh shape. The forming of the first polymer layer may include: disposing a polymer film including a polymer material on the preliminary sheet defined by the light conversion fibers formed in the mesh shape; with the polymer film on the preliminary sheet, providing the polymer film with a pressure and heat directed toward the preliminary sheet; and with the polymer film on the preliminary sheet, curing the polymer material of the polymer film to which the pressure and the heat are provided.

The polymer material of the polymer film to which the pressure and heat are provided is melted when the pressure and the heat are provided to the polymer film, and the melted polymer material infiltrates areas between the light conversion fibers of the preliminary sheet.

The disposing the polymer film including the polymer material includes disposing plural polymer films respectively at opposing sides of the preliminary sheet defined by the light conversion fibers in the mesh shape.

The transparent inorganic material may include at least one of silica, aluminum oxide, zirconium oxide and zinc oxide.

The original solution may include at least one of tetra ethoxy silane, (Si(OC₂H₅)₄), tetra isopropoxy silane (Si(OC₃H₇)₄), aluminum butoxide (C₁₂H₂₇AlO₃), aluminum acetate (Al(OH)(C₂H₃O₂)₂), zinc acetate (C₄H₆O₄Zn) and zirconium oxychloride (ZrOCl₂).

### BRIEF DESCRIPTION OF THE DRAWINGS

The above and other advantages and features of this disclosure will become more apparent by describing in further detail exemplary embodiments thereof with reference to the accompanying drawings, in which:

FIG. 1A is an exploded perspective view of an exemplary embodiment of a display apparatus according to the invention;

FIG. 1B is a cross-sectional view of the display apparatus taken along line I-I′ illustrated in FIG. 1A;

FIGS. 2A and 2B are a perspective view and an enlarged perspective view, respectively, illustrating an exemplary embodiment of a quantum dot sheet according to the invention;

FIG. 3 is an enlarged cross-sectional view of region A of FIG. 1B;

FIG. 4 is an exploded perspective view of another exemplary embodiment of a display apparatus according to the invention;

FIG. 5A is an exploded perspective view of still another exemplary embodiment of a display apparatus according to the invention;

FIG. 5B is a perspective view of the quantum dot sheet illustrated in FIG. 5A;

FIGS. 5C_1, 5C_2 and 5C_3 are cross-sectional and enlarged cross-sectional views of the quantum dot sheet taken along line I-I′ illustrated in FIG. 5B;

FIGS. 6A and 6B are views illustrating preparing a solution in an exemplary embodiment of manufacturing a quantum dot sheet according to the invention;

FIG. 7 is a view illustrating an electrospinning apparatus for an exemplary embodiment of manufacturing a quantum dot sheet according to the invention; and

FIGS. 8A to 8C are views illustrating processes related to pressing polymer films in an exemplary embodiment of manufacturing a quantum dot sheet according to the invention.

### DETAILED DESCRIPTION

Features of the present disclosure, and implementation methods thereof will be described through exemplary embodiments described herein with reference to the accompanying drawings. The present disclosure may, however, be embodied in different forms and should not be construed as limited to the embodiments set forth herein. Rather, these embodiments are provided to more fully convey the scope of the present disclosure to those skilled in the art as set forth in the claims and their equivalents. Like or similar reference numerals refer to like elements throughout.

It will be understood that when an element or a layer is referred to as being “above” of “on” another element or layer, it may be directly above or on the other element or layer, or intervening layers or elements may also be present. On the contrary, when an element is referred to as being “directly on” another element or layer, it will be understood that no intervening layers or elements are present.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” The term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The terms “below,” “beneath,” “lower,” “above” and “upper” representing spatial relativity may be used to easily describe the correlation between one element or component and another element or component as shown in the drawings. The terms representing spatial relativity should be understood as terms including different directions of an element in use or in operation in addition to the direction shown in the drawings.

It will be understood that, although the terms first, second, etc. may be used herein to describe various elements, components, and/or sections, these elements, components, and/or sections should not be limited by these terms. These terms are mainly used to distinguish one element, component, and/or section from another element, component, and/or section. Thus, for example, a first element, a first component or a first section discussed below may instead be termed a second element, a second component or a second section without departing from the teachings of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments in the present disclosure will be described with reference to plan views and cross-sectional views that may be idealized, schematic diagrams of embodiments of the present disclosure. Accordingly, shapes of the exemplary views may be modified according to, for example, manufacturing techniques and/or allowable errors as would be apparent to one of ordinary skill. Therefore, embodiments of the present disclosure are not limited to the specific shapes illustrated in the example views, but may include other shapes that may be created according to routine or described manufacturing processes as would be apparent to one of ordinary skill. Areas shown in the drawings have general properties, and may be used to illustrate a specific shape of a semiconductor package region. Thus, this should not be construed as limiting the scope of the present disclosure.

Hereinafter, exemplary embodiments will be described in detail with reference to the accompanying drawings.

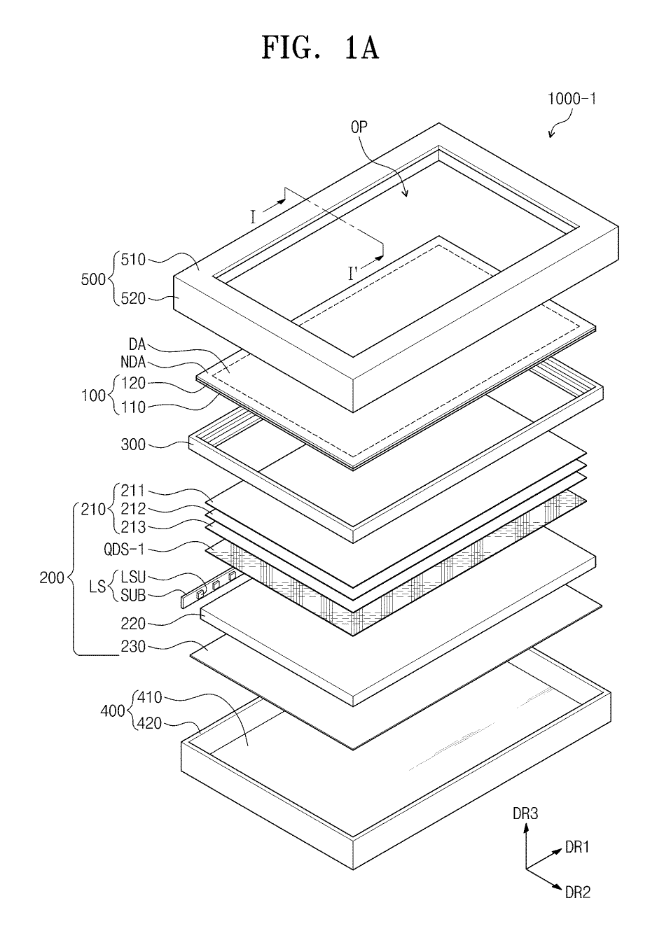

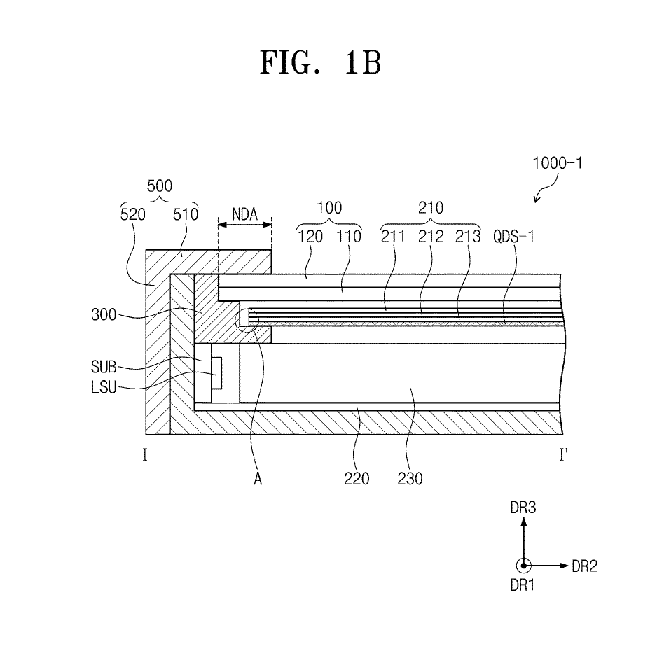

FIG. 1A is an exploded perspective view of an exemplary embodiment of a display apparatus according to the invention, and FIG. 1B is a cross-sectional view of the display apparatus taken along line I-I′ illustrated in FIG. 1A.

Referring to FIGS. 1A and 1B, a display apparatus 1000-1 includes a display panel 100, a backlight unit 200, a mold frame 300, a receiving member 400 and a cover member 500.

In the illustrated embodiment, the display panel 100 may be a liquid crystal display panel. That is, the display panel 100 may include a display substrate 110 which displays an image by using the light received from the backlight unit 200 and in which a plurality of pixels (not shown) that display an image by using the light received from the backlight unit 200 are disposed; and a facing substrate 120 disposed so as to face the display substrate 110. Although not shown, the display panel 100 may include a liquid crystal layer z interposed between the display substrate 110 and the facing substrate 120.

The display panel 100 includes a display region DA at which the pixels (not shown) are disposed and a non-display region NDA around the display region DA. In a top plan view of the display panel 100, the display region DA may be a region of the display panel 100 except for the non-display region NDA. The non-display region NDA may exclude the pixels. The display panel 100 displays an image through the display region DA.

The backlight unit 200 is disposed at the rear side of the display panel 100 and provides the display panel 100 with light. The backlight unit 200 may be an edge-type backlight unit. However, the invention is not limited to the edge-type of the backlight unit. According to another exemplary embodiment of the invention, the backlight unit 200 may be a direct-type backlight unit.

The backlight unit 200 may include a light source LS, an optical sheet 210, a quantum dot sheet QDS-1, a light guide plate 220 and a reflective sheet 230.

The display panel 100, the optical sheet 210, the quantum dot sheet QDS-1, the light guide plate 220 and the reflective sheet 230 each may have or define relatively long sides thereof extended in a first direction DR1, and relatively short sides thereof extended in a second direction DR2 which crosses the first direction DR1.

The light source LS may be disposed adjacent to one side of the light guide plate 220 in the second direction DR2. The reflective sheet 230 may be disposed under the light guide plate 220, and the optical sheet 210 may be disposed over the light guide plate 220. The display panel 100 may be disposed over the optical sheet 210.

The light source LS generates light to be provided to the display panel 100 and thereby provides the light guide plate 220 with the light. The light outputted from the light source LS and provided to the light guide plate 220 may be blue light. The light source LS includes a light source substrate SUB and a light source unit LSU which is provided in plural mounted on the light source substrate SUB.

The light source substrate SUB defines a length thereof which extends in the first direction DR1. The light source units LSU may be disposed on the light source substrate SUB at intervals in the first direction DR1. The light source units LSU generate light. The light generated from the light source units LSU may be provided to the light guide plate 220.

The light guide plate 220 may have an overall plate shape. The light guide plate 220 may define a light exit surface thereof facing the display panel 100, a bottom surface thereof opposite to the light exit surface, and side surfaces which connect the light exit surface and the bottom surface to each other. The light guide plate 220 changes the traveling direction of the light received from the light source units LSU such that the light may be directed toward an upper portion thereof and through the light exit surface where the display panel 100 may be disposed. Although not shown, at the bottom surface of the light guide plate 220, patterns, grooves or the like may be formed on or defined by the light guide plate 220 to scatter the light incident thereto. Patterns, grooves and the like may also be on or defined by the upper surface (e.g., the light exit surface) of the light guide plate 220.

The light guide plate 220 includes a material having a relatively high light transmittance within the visible light range. In an exemplary embodiment, for example, the light guide plate 220 may include polymethylmethacrylate (“PMMA”).

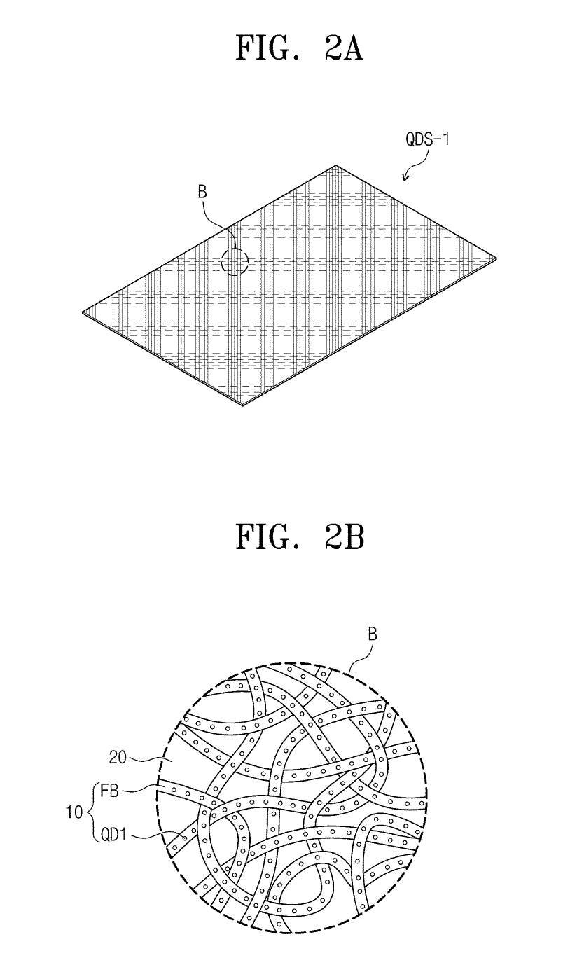

The quantum dot sheet QDS-1 may be disposed over the light guide plate 220. A plurality of quantum dots (not shown) may be provided inside the quantum dot sheet QDS-1. The light provided to the quantum dot sheet QDS-1 through the light guide plate 220 may be blue light. The blue light may be converted into white light by the quantum dots (not shown) of the quantum dot sheet QDS-1. The converted white light may be provided from the quantum dot sheet QDS-1 to the optical sheet 210. Hereinafter, the quantum dot sheet QDS-1 will be described in detail with reference to FIGS. 2A and 2B.

The optical sheet 210 may be disposed between the quantum dot sheet QDS-1 and the display panel 100. The light provided from the quantum dot sheet QDS-1 to the optical sheet 210 may be spread and collected by the optical sheet 210 and may thereby be provided to the display panel 100. The optical sheet 210 may include individual sheets such as a spread (e.g., diffusion) sheet 211, a prism sheet 212 and a protective sheet 213.

The reflective sheet 230 may be disposed under the light guide plate 220. The reflective sheet 230 upwardly reflects the light emitted from under the light guide plate 220. The reflective sheet 230 includes a light-reflecting material. In an exemplary embodiment, for example, the reflective sheet 230 may include aluminum.

The mold frame 300 may be disposed over the light guide plate 220. In the illustrated exemplary embodiment, the mold frame 300 has a frame shape. Specifically, the mold frame 300 may be disposed so as to correspond to peripheral or edge regions of the light guide plate 220. The mold frame 300 functions to fix the display panel 100 and the backlight unit 200 within the display apparatus 1000-1.

The cross-section of the mold frame 300 has a stepped shape. Specifically, the mold frame 300 defines a plurality of horizontal portions thereof in different planes disposed at inside the frame shape thereof. The horizontal portions are extended parallel to a plane defined by the first direction DR1 and the second direction DR2, and each of the horizontal portions may form a step with respect to an adjacent horizontal portion.

The display panel 100, the quantum dot sheet QDS-1 and the optical sheet 210 may be disposed on the horizontal portions defined inside the mold frame 300. Accordingly, the display panel 100, the quantum dot sheet QDS-1 and the optical sheet 210 may be disposed so as to be respectively spaced apart from one another by the stepped shape of the mold frame 300.

The receiving member 400 includes or defines a bottom portion 410 and a side wall portion 420 connected to the bottom portion 410. The receiving member 400 may be disposed as a lowest element of the display apparatus 1000-1 to receive the backlight unit 200 therein. In an exemplary embodiment of the invention, the light source LS may be disposed on an inner side surface of the side wall portion 420 of the receiving member 400. The receiving member 400 may include a relatively rigid metal material. The side wall portion 420 may defined by portions of the receiving member 400 which respectively extend from edges of the bottom portion 410.

The cover member 500 may be disposed over the display panel 100. The cover member 500 has a frame shape. The cover member 500 includes a first cover portion 510 for covering the non-display region NDA of the display panel 100, a second cover portion 520 defining a side wall of the cover member 500, and an opening OP defined inside and by the first cover portion 510 to thereby expose the display region DA of the display panel 100.

The second cover portion 520 may be connected to or extended from the outer side of the first cover portion 510 and extends downward toward the receiving member 400. That is, the first and second cover portions 510 and 520 may be disposed perpendicular to each other. The second cover portion 520 may be disposed so as to surround or face outer side surfaces of the receiving member 400.

FIGS. 2A and 2B are a perspective view and an enlarged perspective view, respectively, illustrating an exemplary embodiment of a quantum dot sheet according to the invention.

Referring to FIGS. 2A and 2B, the quantum dot sheet QDS-1 includes or is defined by a light conversion fiber 10 provided in plural and a first polymer layer 20. Particularly, FIG. 2B is an enlarged perspective view of region B of FIG. 2A.

Each of the light conversion fibers 10 includes a base fiber FB and a first quantum dot QD1 provided in plural within the base fiber FB. The first quantum dots QD1 may be scattered inside each of the fibers 10. The first quantum dots QD1 absorb the blue light provided from the light source units LSU and may thereby discharge red light or green light. Accordingly, blue light the wavelength of which may be not converted by the first quantum dots QD1 among the blue light provided from the light source units LSU may be mixed with green light and red light and may thereby be finally realized as white light.

The base fiber FB may include an inorganic material. The inorganic material may have a light-transmitting property. According to an exemplary embodiment of the invention, the base fiber FB may include at least one of silica (SiO₂), aluminum oxide (Al₂O₃), zirconium oxide (ZrO₂) and zinc oxide (ZnO).

Within the quantum dot sheet QDS-1, the light conversion fibers 10 may be laminated to each other while crossing one another to thereby form an overall mesh shape. In an exemplary embodiment of manufacturing a display apparatus, the light conversion fibers 10 of the quantum dot sheet QDS-1 may be formed through an electrospinning method to be described later.

The light conversion fibers 10 may be contained in the first polymer layer 20. That is, the first polymer layer 20 may be disposed so as to cover the light conversion fibers 10. The base fibers FB of the light conversion fibers 10 may be fixed to the first polymer layer 20, and thus the overall mesh shape of the light conversion fibers 10 may be maintained by the first polymer layer 20. The first polymer layer 20 and the light conversion fibers 10 of which a shape thereof is maintained by the first polymer layer 20 defines an entirety of the quantum dot sheet QDS-1. The first polymer layer 20 may define outermost surfaces of the quantum dot sheet QDS-1.

In the illustrated exemplary embodiment, the first polymer layer 20 includes a thermosetting polymer material. In an exemplary embodiment, for example, the first polymer layer 20 may include at least one of polyethylene terephthalate (“PET”), polymethyl methacrylate (“PMMA”), polycarbonate (“PC”), triacetate cellulose (“TAC”) and cycloolefin polymer (“COP”).

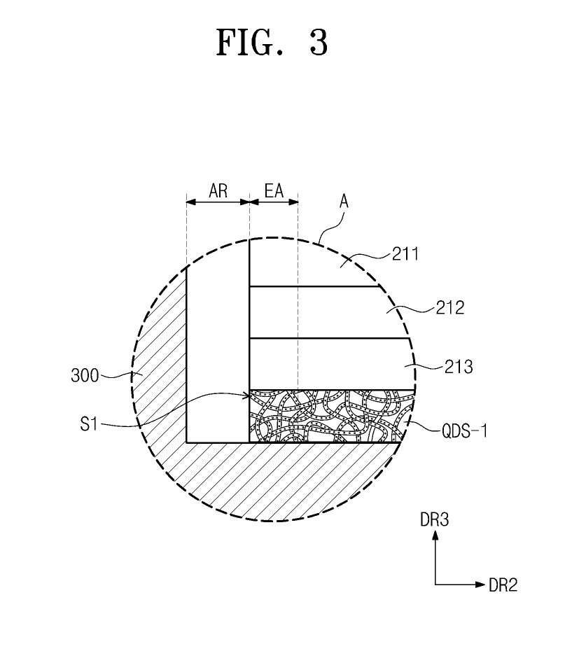

FIG. 3 is an enlarged cross-sectional view of region A of FIG. 1B.

Referring to FIG. 3, in the second direction DR2, a first space AR may be defined between a peripheral area EA of the quantum dot sheet QDS-1 and the inner side surface of the mold frame 300. That is, the quantum sheet QDS-1 may be disposed to be spaced apart from the mold frame 300 with the first space AR defined therebetween. While only one side surface of the quantum dot sheet QDS-1 is shown in FIG. 3, the same structure is applicable to each of four side surfaces of the quantum dot sheet QDS-1. Accordingly, peripheral side surfaces S1 of the quantum dot sheet QDS-1 facing the inner side surface of the mold frame 300 may be exposed to the first space AR.

According to an exemplary embodiment of the invention, the base fibers FB in which the first quantum dots QD1 are disposed include a transparent inorganic material. In an exemplary embodiment, for example, the transparent inorganic material may be glass.

Also, the transparent inorganic material may include at least one of silica (SiO₂), aluminum oxide (Al₂O₃), zirconium oxide (ZrO₂) and zinc oxide (ZnO). As compared to an organic material, the inorganic material is stronger in blocking external air or water/moisture. Therefore, the base fibers FB including a transparent inorganic material effectively block external air or moisture from reaching the first quantum dots QD1 disposed therein. The base fibers FB may completely cover the first quantum dots QD1 disposed therein such that no portion of the first quantum dots QD1 is exposed to outside the light conversion fibers 10 or the quantum dot sheet QDS-1. Since the first polymer layer 20 and the light conversion fibers 10 of which the shape thereof is maintained by the first polymer layer 20 defines an entirety of the quantum dot sheet QDS-1 and since the base fibers FB completely cover the first quantum dots QD1 such that no portion of the first quantum dots QD1 is exposed, a separate protection sheet for the quantum dot sheet QDS-1 is obviated. That is, since a portion of the base fibers FB is disposed between each of the first quantum dots QD1 and an outside of the first polymer layer 20, separate protection sheet for the quantum dot sheet QDS-1 is obviated.

For a conventional display apparatus, when light conversion fiber structure described above is not provided for a quantum dot sheet or base fibers and quantum dots are separated or exposed within light conversion fiber structure, the quantum dots which may be disposed at a peripheral area of the quantum dot sheet may be deteriorated due to external air or water infiltrating into the peripheral side surfaces of the quantum dot sheet exposed to a space adjacent to the quantum dot sheet. As a result, the display quality of the conventional display apparatus at the peripheral region of the quantum dot sheet may be deteriorated, and in light of this, a dead space of the conventional display apparatus may be increased.

However, in one or more exemplary embodiment of the quantum dot sheet QDS-1 according to the invention, since the base fibers FB including an inorganic material block external air or water infiltrating into the first quantum dots QD1 disposed therein, the display apparatus including the quantum dot sheet QDS-1 may have a minimized dead space.

Referring to FIG. 1B, a bezel of the display apparatus 1000-1 may be defined by a dimension of the first cover portion 510 of the cover member 500 taken in the second direction DR2 or in a top plan view. The bezel may include the non-display area NDA of the display panel 100 and the region A at which the peripheral area EA of the quantum dot sheet QDS-1 is disposed. Since one or more exemplary embodiment of the quantum dot sheet QDS-1 according to the invention has a minimized dead space by the light conversion fibers 10, the bezel of the display apparatus 1000-1 may be decreased.

Also, according to an exemplary embodiment of the invention, even though the quantum dots are totally scattered within the quantum dot sheet QDS-1, the quantum dots may be protected even at the peripheral region EA of the quantum dot sheet QDS-1 exposed to the first space AR by the base fibers FB. Since the quantum dots are protected even at the peripheral region EA of the quantum dot sheet QDS-1 by the base fibers FB, separate protection films such as polymer films which have been disposed over and under a conventional quantum dot sheet may be not omitted. Since separate protection films are obviated according to one or more exemplary embodiment of the invention, an overall thickness of the quantum dot sheet QDS-1 may be decreased.

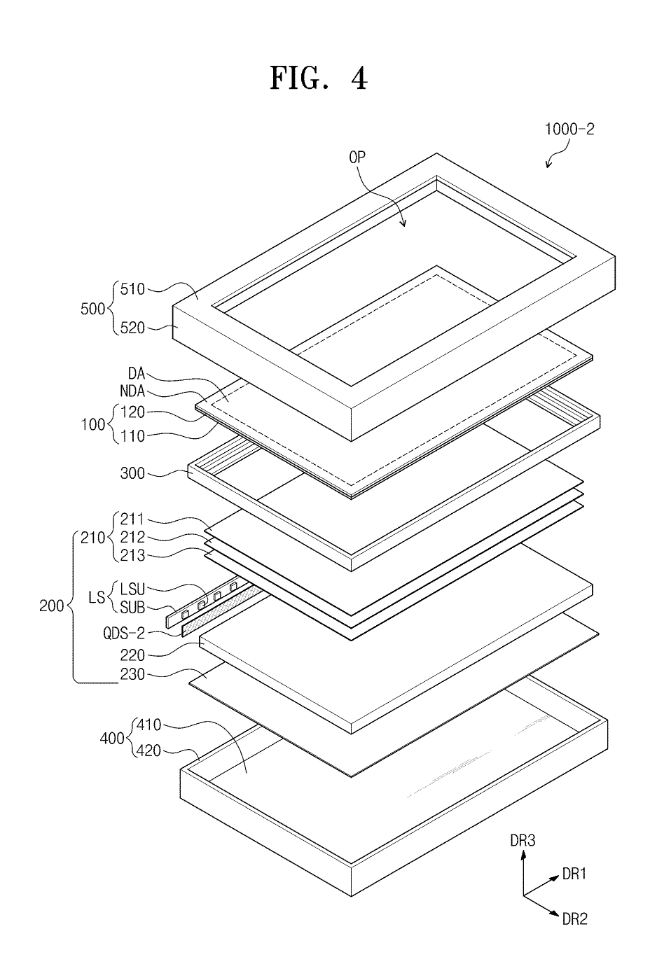

FIG. 4 is an exploded perspective view of another exemplary embodiment of a display apparatus according to the invention. In describing FIG. 4, previously described components will be designated by the same reference numerals, and overlapping descriptions thereof will not be provided.

Referring to FIG. 4, an exemplary embodiment of a quantum dot sheet QDS-2 of a display apparatus 1000-2 according to the invention may be disposed between one side surface of a light guide plate 220 facing light source units LSU among side surfaces of the light guide plate 220, and the light source units LSU. The quantum dot sheet QDS-2 may be disposed in parallel with a light source substrate SUB. Except for the position of the quantum dot sheet QDS-2 in the display apparatus 1000-2, remaining components and structures may be the same as those illustrated in FIG. 1B.

Specifically, according to an exemplary embodiment of the invention, the quantum dot sheet QDS-2 has a plate shape parallel to a plane defined by first and third directions DR1 and DR3. The third direction DR3 may be defined as a direction perpendicular to the first and second directions DR1 and DR2. The third direction DR3 may be a reference direction for upward and downward directions of the display apparatus 1000-2.

The light provided to the quantum dot sheet QDS-2 by the light source unit LSU may be blue light. The blue light may be converted into white light by the quantum dots of the quantum dot sheet QDS-2. The converted white light may be provided to the light guide plate 220 through a light incident side surface defined thereby.

The quantum dot sheet QDS-2 may be disposed between the light source unit LSU and the light guide plate 220 which are spaced apart from each other, and may thereby exposed to external air or water at a space defined between the spaced apart light source unit LSU and the light guide plate 220. Referring again to FIGS. 2A and 2B, since base fibers which coat the quantum dots of the quantum dot sheet QDS-2 in one or more exemplary embodiment according to the invention include an inorganic material, damage of the quantum dots due to external air or water may be reduced or effectively prevented. Consequently, according to one or more exemplary embodiment of the invention, deterioration of the display quality of the display apparatus 1000-2 due to damage to the quantum dot sheet QDS-2 may be reduced or effectively prevented.

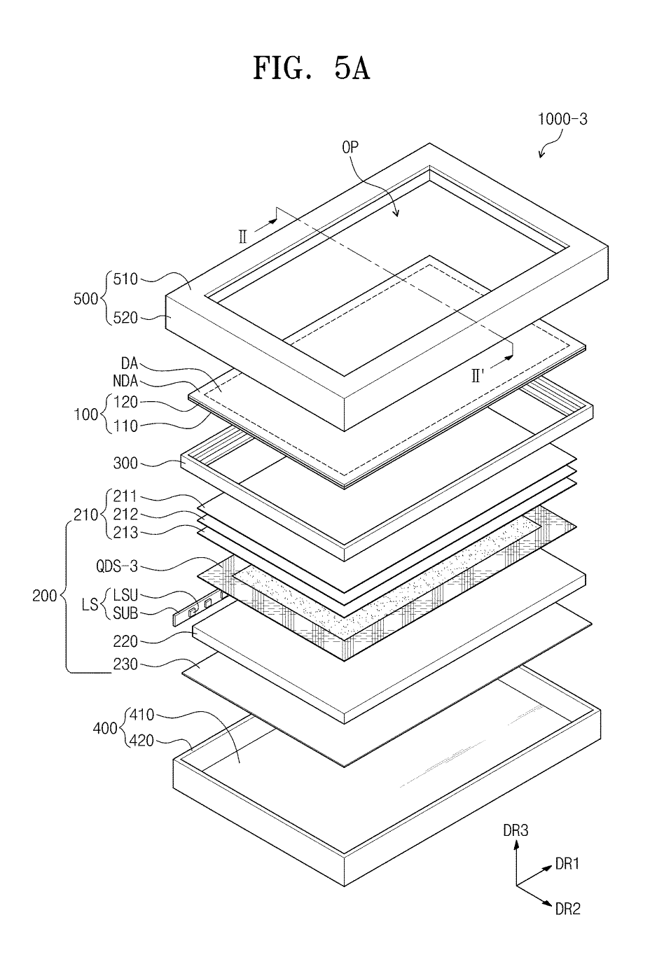

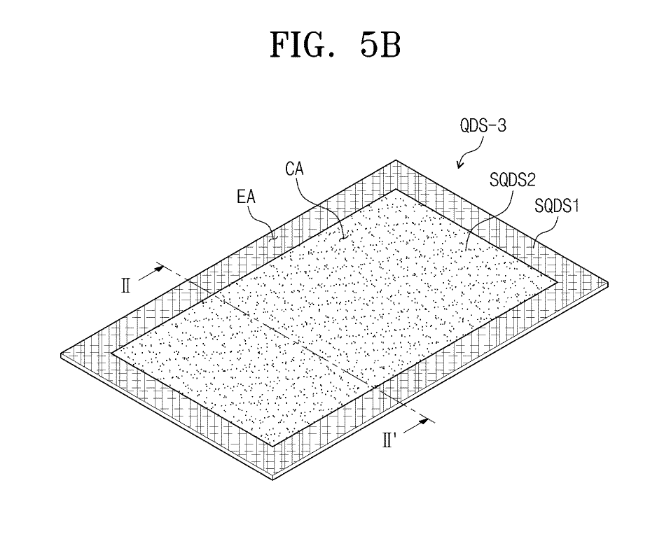

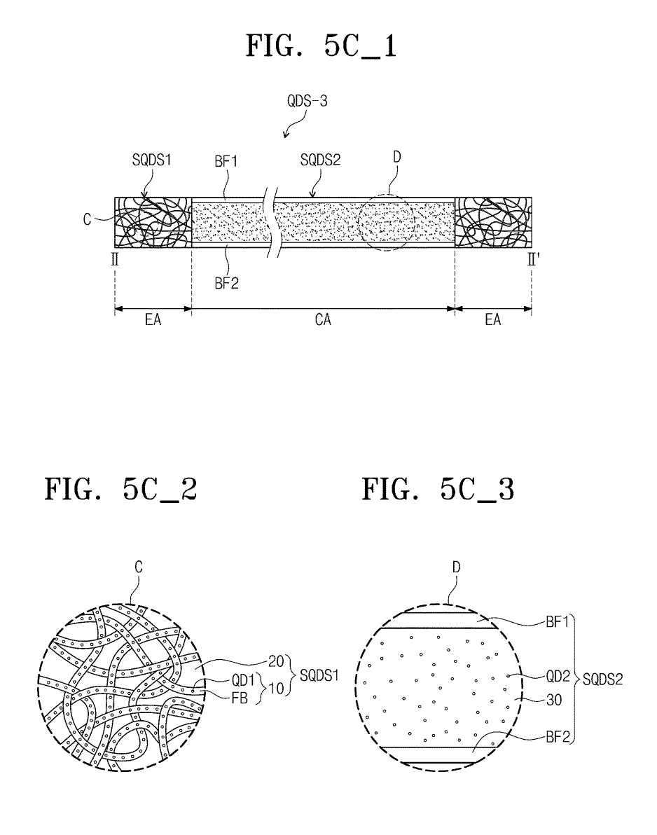

FIG. 5A is an exploded perspective view of still another exemplary embodiment of a display apparatus according to the invention, and FIG. 5B is a perspective view of the quantum dot sheet illustrated in FIG. 5A. FIG. 5C_1 is a cross-sectional view of the quantum dot sheet taken along line II-II′ illustrated in FIG. 5B, and FIGS. 5C_2 and 5C_3 are enlarged cross-sectional views of regions C and D of FIG. 5C_1. In describing FIGS. 5A to 5C_3, previously described components will be designated by the same reference numerals, and overlapping descriptions thereof will not be provided.

Referring to FIGS. 5A to 5C_3, an exemplary embodiment of a quantum dot sheet QDS-3 according to the invention be divided into or define a peripheral region EA and a central region CA which is surrounded by the peripheral region EA. The peripheral region EA and the central region CA may define an entirety of the quantum dot sheet QDS-3. A first structure SQDS1 may be disposed in the peripheral region EA. A second structure SQDS2 may be disposed in the central region CA. The first and second structures SQDS1 and SQDS2 have an integral shape. That is, an elemental component of one of the first and second structures SQDS1 and SQDS2 in a respective region among the peripheral region EA and the central region CA may extend from the respective region to be disposed in the other region.

The first structure SQDS1 includes a light conversion fiber 10 provided in plural and a first polymer layer 20. Each of the light conversion fibers 10 includes a base fiber FB and a first quantum dot QD provided in plural therein. The functions and characteristics of the first quantum dots QD1 in the first structure SQDS1 may be the same as those of the first quantum dots QD1 described above. Hereinafter, since components of the first structure SQDS1 may be the same as those of the quantum dot sheet QDS-1 described above, the description of the components of the first structure SQDS1 will not be provided.

The second structure SQDS2 includes a first barrier film BF1, a second barrier film BF2 and a second polymer layer 30. The first barrier film BF1 may be disposed so as to face the second barrier film BF2 with the second polymer layer 30 disposed therebetween. The first structure SQDS1 and the second structure SQDS2 may define an entirety of the quantum dot sheet QDS-3.

A second quantum dot QDR2 may be provided in plural scattered in the second polymer layer 30. That is, each of the second quantum dots QDR2 may be coated by the second polymer layer 30. Since the functions and characteristics of the second quantum dots QDR2 may be the same as those of the first quantum dots QDR1 described above, the description thereof will not be provide. The second structure SQDS1 may exclude the base fiber FB with respect to the second quantum dots QDR2, but the invention is not limited thereto.

The second polymer layer 30 functions to fix the second quantum dots QDR2 within the central area CA so as not to deviate from positions thereof. The second polymer layer 30 includes a thermosetting polymer material. In an exemplary embodiment, for example, the second polymer layer 30 may include at least one of polyethylene terephthalate (“PET”), polymethyl methacrylate (“PMMA”), poly carbonate (“PC”), triacetate cellulose (“TAC”) and cycloolefin polymer (“COP”).

Referring to FIG. 5C_1, even where the second quantum dots QDR2 are coated by the second polymer layer 30, a portion of the second quantum dots QDR2 may be exposed at a side surface, an upper surface and a lower surface of the second polymer layer 30. For the upper and lower surfaces of the second polymer layer 30, the first and second barrier films BF1 and BF2 function to reduce or effectively prevent penetration of air or water to the second quantum dots QDR2 in the central region CA. For the side surfaces of the second polymer layer 30, the first structure SQDS1 is disposed to further reduce or effectively prevent penetration of air or water to the second quantum dots QDR2 in the central region CA. The first and second barrier films BF1 and BF2 along with the first polymer layer may define outermost surfaces of the quantum dot sheet QDS-3. Outer surfaces of the first and second barrier films BF1 and BF2 may be coplanar with upper and lower surfaces of the first structure SQDS1.

According to another exemplary embodiment of the invention, since the base fibers FB completely surround the first quantum dots QDR1 in the first structure SQDS1, damage to the quantum dots QDR1 may be reduced or effectively prevented. Also, since the second structure QSDS2 may be surrounded by the first structure SQDS1, damage to the second quantum dots QDR2 due to external air and water may be reduced or effectively prevented.

Accordingly, in one or more exemplary embodiment of a quantum dot sheet according to the invention, deterioration of the display quality of the display apparatus 1000-3 at the peripheral region EA of the quantum dot sheet QDS-3 may be reduced or effectively prevented. That is, for similar reasons discussed above, since one or more exemplary embodiment of the quantum dot sheet QDS-3 according to the invention has a minimized dead space by the light conversion fibers 10 of the first structure SQDS1 at the peripheral region EA, a bezel of a display apparatus 1000-3 may be decreased.

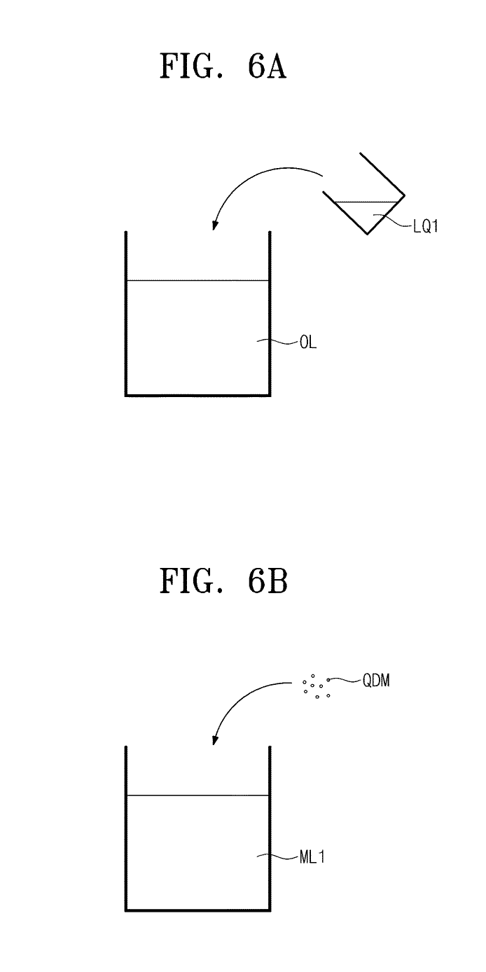

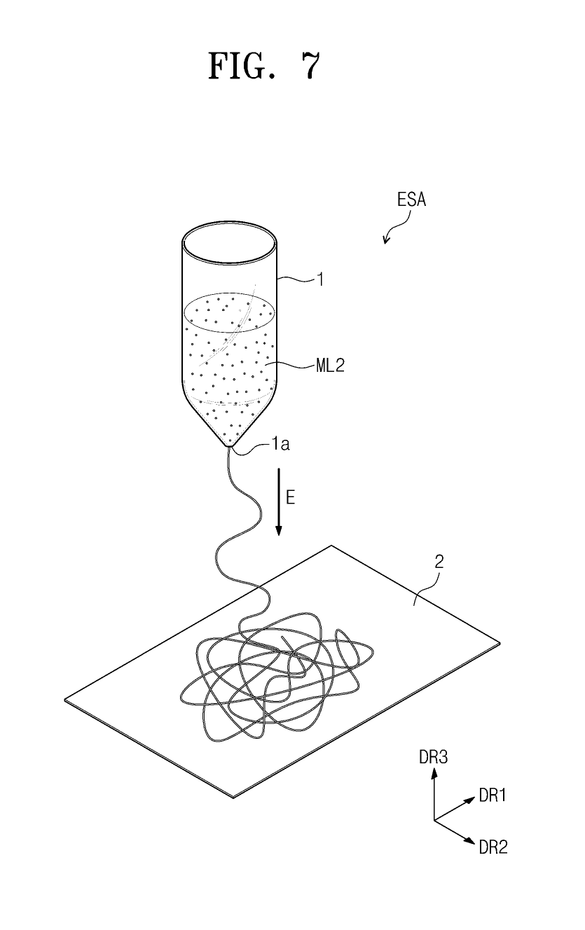

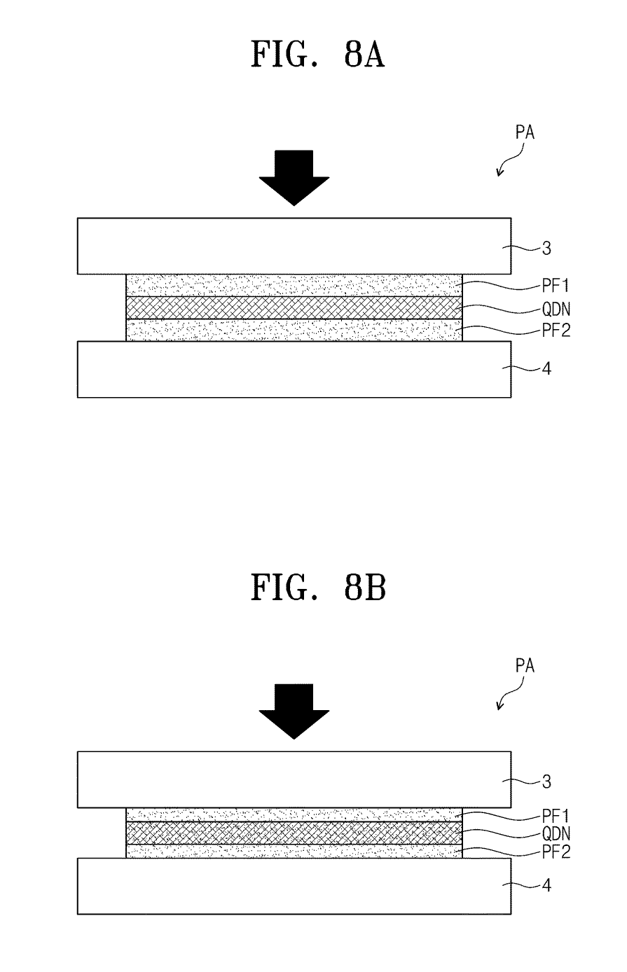

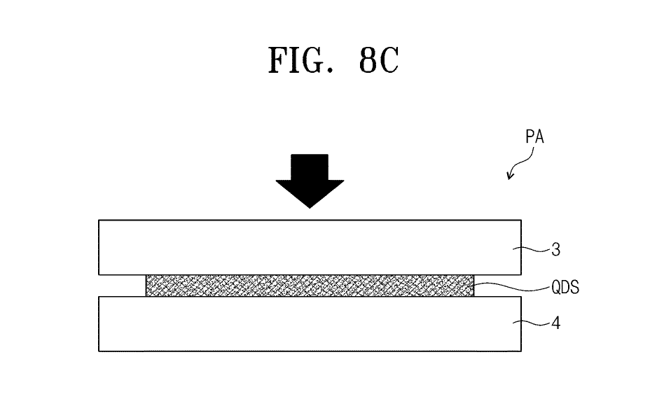

FIG. 6A, FIG. 6B, FIG. 7 and FIG. 8A to FIG. 8C are views illustrating a method for manufacturing a quantum dot sheet according to the invention. FIG. 6 is a view illustrating preparing a solution in an exemplary embodiment of manufacturing a quantum dot sheet, and FIG. 7 is a view illustrating an electrospinning apparatus for an exemplary embodiment of manufacturing a quantum dot sheet according to the invention. FIGS. 8A to 8C are views illustrating processes related to pressing polymer films in an exemplary embodiment of manufacturing a quantum dot sheet according to the invention.

Referring to FIGS. 6A and 6B, a first solution LQ1 may be added to an original solution OL.

In the exemplary embodiment, the original solution OL includes at least one of tetra ethoxy silane, (Si(OC₂H₅)₄), tetra isopropoxy silane (Si(OC₃H₇)₄), aluminum butoxide (C₁₂H₂₇AlO₃), aluminum acetate (Al(OH)(C₂H₃O₂)₂), zinc acetate (C₄H₆O₄Zn) and zirconium oxychloride (ZrOCl₂). However, according to exemplary embodiments of the invention, the original solution OL may be not limited to the above-mentioned material, and may include various materials within a raw material range for forming an inorganic transparent material.

A first reaction may occur between the original solution OL and the first solution LQ1. When the first reaction is completed, the first combined solution ML1 may be prepared. In an exemplary embodiment, for example, the first reaction may be a Sol-Gel reaction. Compared to an initial fluidity of the original solution OL and the first solution LQ1, the fluidity of the first combined solution ML1 may be decreased via the first reaction.

The first solution LQ1 may include solvent which dissolves materials included in the original solution OL. In an exemplary embodiment, for example, the first solution LQ1 may be water (H₂O) or ethanol. However, according to another exemplary embodiment of the invention, the first solution LQ1 may be not limited to the above-mentioned materials, and may further include a catalytic agent (not shown).

The first combined solution ML1 may include a transparent inorganic material. In an exemplary embodiment, for example, according to the invention, the transparent inorganic material may include at least one of silica (SiO₂), aluminum oxide (Al₂O₃), zirconium oxide (ZrO₂), or zinc oxide (ZnO).

A quantum dot material QDM may be added to the first combined solution ML1 and the second combined solution ML2 may be thereby prepared. The quantum dot material QDM includes a plurality of first quantum dots QD1. In an exemplary embodiment, for example, the quantum dot material QDM may be a solvent agent in which the first quantum dots QD1 may be diluted.

Referring to FIG. 7, the second combined solution ML2 may be spun and one or more light conversion fiber may thereby be formed. Spinning the second combined solution ML2 may provide a single, continuous light conversion fiber which is folded back on itself to effectively form layers light conversion fibers or may provide discrete lengths of light conversion fibers. According to an exemplary embodiment of the invention, the light conversion fibers may be formed through an electrospinning method. While the electrospinning method is described, the invention is not limited to spinning methods of light conversion fibers, and light conversion fibers may be formed through various spinning methods, such as a wet spinning, a dry spinning, a dry/wet spinning, melt spinning and the like.

An electrospinning apparatus (“ESA”) according to an exemplary embodiment of an electrospinning method includes a spinning container 1 and a stage 2. The spinning container 1 includes a spinning nozzle 1a. A second combined solution ML2 may be received in the spinning container 1. Accordingly, the second combined solution ML2 may be injected through the spinning nozzle 1a.

An electric field may be formed between the spinning nozzle 1a of the spinning container 1 and the stage 2. In an exemplary embodiment, for example, a relatively high voltage may be applied to the spinning nozzle 1a and thus the electric field E may be formed between the spinning nozzle 1a and the stage 2 having a potential which may be relatively lower than the potential of the spinning nozzle 1a.

The second combined solution ML2 may be continuously injected through the spinning nozzle 1a by the electric field E. The injected second combined solution ML2 may have shapes of a plurality of light conversion fibers having predetermined diameters. The light conversion fibers formed by injection of the second combined solution ML2 through the spinning nozzle 1a may be stacked on the stage 2. The light conversion fibers may be stacked in the third direction DR3.

One of the spinning nozzle 1a or the stage 2 may be moved in a plane relative to the other of the spinning nozzle 1a or the stage 2. Accordingly, the light conversion fibers may be stacked so as to define a predetermined thickness with respect to the stage 2. The stacked light conversion fibers define a mesh shape. A drying process may be performed to the stacked light conversion fibers and a preliminary sheet QDN may thereby be formed.

Referring to FIG. 8A to 8C, a pressing apparatus PA may be provided. The pressing apparatus PA includes an upper jig 3 and a lower jig 4. The upper jig 3 and a lower jig 4 may be disposed so as to face each other. A first polymer film PF1 may be disposed under the upper jig 3, and a second polymer film PF2 may be disposed on the lower jig 4. The preliminary sheet QDN may be disposed between the first and second polymer films PF1 and PF2.

Any one of the upper jig 3 and the lower jig 4 may reciprocate upwardly and downwardly. In an exemplary embodiment of the invention, the upper jig 3 may be upwardly and downwardly moved with respect to the lower jig 4, and the lower jig 4 may not be moved. The first and second polymers PF1 and PF2 may each be respectively pressed (indicated by arrows in FIGS. 8A-8C) toward the preliminary sheet QDN by the reciprocation of the jigs 3 and 4 with respect to each other. Referring to the shading of the first and second polymer films PF1 and PF2 and the shading of the preliminary sheet QDN in FIG. 8A, materials of the respective elements are initially separate from each other.

The upper jig 3 and lower jig 4 may be heated to a predetermined temperature, and may thereby provide heat to the first and second polymer films PF1 and PF2. The polymer materials of the first and second polymer films PF1 and PF2 may be melted by the heat. The polymer materials may include at least one of polyethylene terephthalate (“PET”), polymethyl methacrylate (PMMA), poly Carbonate (PC), triacetate cellulose (TAC), or cycloolefin polymer (COP).

The molten polymer materials may infiltrate between the light conversion fibers of the preliminary sheet QDN by the applied pressure between the upper and lower jigs 3 and 4. Referring to FIG. 8B, the shading of the first and second polymer films PF1 and PF2 is illustrated not only at the first and second polymer films PF1 and PF2 but also within the preliminary sheet QDN in addition to the initial shading of the preliminary sheet QDN. The molten polymer material infiltrating between the light conversion fibers of the preliminary sheet QDN may form a first polymer layer through a curing process. By forming the first polymer layer, the quantum dot sheet QDS may be completed. The quantum dot sheet QDS illustrated in FIG. 8C is the same as the quantum dot sheet QDS-1 described above. In FIG. 8C, the initial shading of the first and second polymer films PF1 and PF2 and the shading of the preliminary sheet QDN is illustrated interdispersed over an entire of the quantum dot sheet QDS.

Consequently, according to one or more exemplary embodiment of a method of manufacturing a quantum dot sheet, for a display apparatus including the quantum dot sheet QDS formed by the method, deterioration of the display quality of the a display apparatus at a peripheral region of the quantum dot sheet QDS may be reduced or effectively prevented, and an overall thickness of the display apparatus and the bezel may be decreased.

According to one or more exemplary embodiment of the invention, a quantum dot sheet includes a transparent inorganic material between quantum dots and an environment outside the quantum dot sheet such that deterioration of the quantum dot sheet may be reduced or effectively prevented. According to one or more exemplary embodiment of the invention, since separate protection films on the quantum dot sheet are obviated, the quantum dot sheet has a decreased overall thickness. Since one or more exemplary embodiment of the quantum dot sheet according to the invention has a minimized dead space by the light conversion fibers therein, a decreased bezel of the display apparatus may be provided.

While exemplary embodiments are described above, a person skilled in the art may understand that many modifications and variations may be made without departing from the spirit and scope of the invention defined in the following claims. Also, exemplary embodiments disclosed in the present disclosure are not intended to limit the technical spirit of the invention and the following claims and all technical spirits falling within equivalent scope are construed as being included in the scope of rights of the invention.

What is claimed is:

1. A quantum dot sheet comprising:
light conversion fibers which convert a wavelength of light provided to the quantum dot sheet; and
a first polymer layer in which the light conversion fibers are disposed,
wherein each of the light conversion fibers is defined by:
first quantum dots which convert the wavelength of the light provided to the quantum dot sheet, and
a base fiber comprising an inorganic material and in which the first quantum dots are disposed.

2. The quantum dot sheet of claim 1, wherein the light conversion fibers form a mesh shape.

3. The quantum dot sheet of claim 1, wherein the inorganic material of the base fiber has a light transmitting property.

4. The quantum dot sheet of claim 3, wherein the inorganic material comprises at least one of SiO₂, Al₂O₃, ZrO₂ and ZnO.

5. The quantum dot sheet of claim 1, further comprising:
a first barrier film;
a second barrier film facing the first barrier film;
second quantum dots which convert the wavelength of the light provided to the quantum dot sheet, and
a second polymer layer in which the second quantum dots are disposed, the second polymer layer with the second quantum dots disposed therein being between the first barrier film and the second barrier film,
wherein
a first structure of the quantum dot sheet is defined by the first polymer layer having the light conversion fibers disposed therein,
a second structure of the quantum dot sheet is defined by the second polymer layer being between the first barrier film and the second barrier film and having the second quantum dots disposed therein, and
in a top plan view, the first structure surrounds the second structure.

6. The quantum dot sheet of claim 1, wherein the first polymer layer and the second polymer layer comprise a thermosetting polymer.

7. A display apparatus comprising:
a display panel which receives light to display an image; and
a backlight assembly which provides the light to the display panel,
wherein the backlight assembly comprises:
a light source which generates and emits the light; and
a quantum dot sheet which is disposed adjacent to the light source and the display panel and converts a wavelength of the light provided from the light source, the quantum dot sheet comprising:
light conversion fibers which convert the wavelength of the light provided from the light source, and
a first polymer layer in which the light conversion fibers are disposed,
wherein each of the light conversion fibers is defined by:
first quantum dots which convert the wavelength of the light provided from the light source, and
a base fiber comprising an inorganic material and in which the first quantum dots are disposed.

8. The display apparatus of claim 7, wherein
the backlight assembly further comprises a light guide plate, and
the quantum dot sheet is disposed between the light guide plate and the display panel.

9. The display apparatus of claim 7, wherein
the backlight assembly further comprises a light guide plate, and
the quantum dot sheet is disposed between the light guide plate and the light source.

10. The display apparatus of claim 7, wherein the light conversion fibers of the quantum dot sheet form a mesh shape.

11. The display apparatus of claim 7, wherein the inorganic material of the base fiber of the quantum dot sheet has a light transmitting property.

12. The display apparatus of claim 7, wherein the quantum dot sheet further comprises:
a first barrier film;
a second barrier film facing the first barrier film;
second quantum dots which convert the wavelength of the light provided from the light source, and
a second polymer layer in which the second quantum dots are disposed, the second polymer layer with the second quantum dots disposed therein being between the first barrier film and the second barrier film,
wherein
a first structure of the quantum dot sheet is defined by the first polymer layer having the light conversion fibers disposed therein,
a second structure of the quantum dot sheet is defined by the second polymer layer being between the first barrier film and the second barrier film and having the second quantum dots disposed therein, and
in a top plan view, the first structure surrounds the second structure.

13. A method for manufacturing a quantum dot sheet, the method comprising:
preparing a combined solution by providing a quantum dot material to an original solution including a transparent inorganic material;
forming light conversion fibers by spinning the combined solution; and
forming a first polymer layer so as to cover the spun light conversion fibers, to form the quantum dot sheet.

14. The method of claim 13, wherein the forming of the light conversion fibers comprises:
forming the light conversion fibers in a mesh shape; and
drying the light conversion fibers in the mesh shape.

15. The method of claim 14, wherein the light conversion fibers are formed by an electrospinning method.

16. The method of claim 14, wherein
a preliminary sheet is defined by the light conversion fibers formed in the mesh shape, and
the forming of the first polymer layer comprises:
disposing a polymer film including a polymer material on the preliminary sheet defined by the light conversion fibers in the mesh shape;
with the polymer film on the preliminary sheet, providing the polymer film with a pressure and heat directed toward the preliminary sheet; and
with the polymer film on the preliminary sheet, curing the polymer material of the polymer film to which the pressure and the heat are provided.

17. The method of claim 16, wherein the polymer material of the polymer film to which the pressure and heat are provided is melted when the pressure and the heat are provided to the polymer film, and the melted polymer material infiltrates areas between the light conversion fibers of the preliminary sheet.

18. The method of claim 17, wherein the disposing the polymer film including the polymer material comprises disposing plural polymer films respectively at opposing sides of the preliminary sheet defined by the light conversion fibers in the mesh shape.

19. The method of claim 13, wherein the transparent inorganic material comprises at least one of silica, aluminum oxide, zirconium oxide and zinc oxide.

20. The method of claim 13, wherein the original solution comprises at least one of tetra ethoxy silane, (Si(OC₂H₅)₄), tetra isopropoxy silane (Si(OC₃H₇)₄), aluminum butoxide (C₁₂H₂₇AlO₃), aluminum acetate (Al(OH)(C₂H₃O₂)₂), zinc acetate (C₄H₆O₄Zn) and zirconium oxychloride (ZrOCl₂).
